(19) United States
(12) Patent Application Publication
(10) Pub. No.: US 2015/0052197 A1
(43) Pub. Date: Feb. 19, 2015

(54) METHOD AND SYSTEM FOR OPERATING AN APPLIANCE

(71) Applicant: General Electric Company, Schenectady, NY (US)

(72) Inventors: William Jerome Burke, Louisville, KY (US); Sreenivas Tallapragada, Hyderabad (IN); Balakrishna Subramaniam, Prospect, KY (US); Kihwan Park, Suwon (KR); William Wesley Bornor, Plymouth, MI (US)

(73) Assignee: General Electric Company, Schenectady, NY (US)

(21) Appl. No.: 13/966,566

(22) Filed: Aug. 14, 2013

(51) Int. Cl. H04L 29/08

(52) U.S. Cl. CPC H04L 67/12
USPC 709/204

(57) ABSTRACT

A method and system for operating an appliance are provided. An exemplary method includes providing a module with a meta-resource and associating the meta-resource of the module with a resource of the appliance. The exemplary method also includes utilizing the meta-resource of the module to operate the resource of the appliance. The meta-resource can supplement or enhance functionality of the appliance. An exemplary system includes an appliance having a resource and a module having a meta-resource. The meta-resource of the module is configured for utilizing the resource of the appliance in order to supplement functionality of the appliance.

### FIELD OF THE INVENTION

The present subject matter relates generally to methods and systems for operating appliances, such as networked appliances. More particularly, the present subject matter relates to methods and systems for providing additional functionality to networked appliances.

### BACKGROUND OF THE INVENTION

Certain appliances include controllers programmed to regulate the appliances' operations. Such controllers can be programmed to selectively operate various appliance components in order to facilitate user interaction with the appliances. Such controllers can also permit expanded appliance functionality relative to appliances without such controllers.

Appliance controllers are generally programmed prior to or during manufacture of the appliance. After manufacturing of the appliance is complete, updating or reprogramming an appliance's controller can be difficult. However, new appliance features and options are frequently developed after the appliance is manufactured. Such new features can provide valuable new functionality and appeal to the appliances' users.

Accordingly, methods and systems for operating an appliance in order to provide additional appliance functionality would be useful. In particular, methods and systems for operating an appliance in order to provide additional appliance functionality without requiring reprogramming of the appliance would be useful.

### BRIEF DESCRIPTION OF THE INVENTION

The present subject matter provides a method and system for operating an appliance. An exemplary method includes providing a module with a meta-resource and associating the meta-resource of the module with a resource of the appliance. The exemplary method also includes utilizing the meta-resource of the module to operate the resource of the appliance. The meta-resource can supplement or enhance functionality of the appliance. An exemplary system includes an appliance having a resource and a module having a meta-resource. The meta-resource of the module is configured for utilizing the resource of the appliance in order to supplement functionality of the appliance. Additional aspects and advantages of the invention will be set forth in part in the following description, or may be apparent from the description, or may be learned through practice of the invention.

In a first exemplary embodiment, a method for operating an appliance is provided. The appliance has a resource. The method includes providing a module. The module has a meta-resource for supplementing functionality of the appliance. The method also includes associating the meta-resource of the module with the resource of the appliance and utilizing the meta-resource of the module to operate the resource of the appliance.

In a second exemplary embodiment, a system is provided. The system includes an appliance, a module, and a client. The appliance has a resource and a roster. The appliance also has an associated identifier. The appliance is configured for selectively advertising the resource of the appliance. The module has a meta-resource. The module also has an associated identifier. The module is configured for selectively advertising the meta-resource of the module. The client is in operative communication with the appliance and the module. The client has a roster. The identifier of the appliance and the identifier of the module are within the roster of the client. The identifier of the module is within the roster of the appliance. The meta-resource of the module is configured for utilizing the resource of the appliance in order to supplement functionality of the appliance.

In a third exemplary embodiment, a method for operating an appliance is provided. The appliance has a resource and an identifier. A client is in communication with the appliance and a module. The module has a meta-resource and an identifier. The method includes placing the identifier of the appliance in a roster of the client, advertising the resource of the appliance, adding the identifier of the module to the roster of the client and to a roster of the appliance, broadcasting the meta-resource of the module, and utilizing the meta-resource of the module in order to operate the resource of the appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a schematic view of a system for operating an appliance according to an exemplary embodiment of the present subject matter.

FIG. 2 illustrates a method for operating an appliance according to an exemplary embodiment of the present subject matter.

FIG. 3 illustrates a method for operating an appliance according to an additional exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

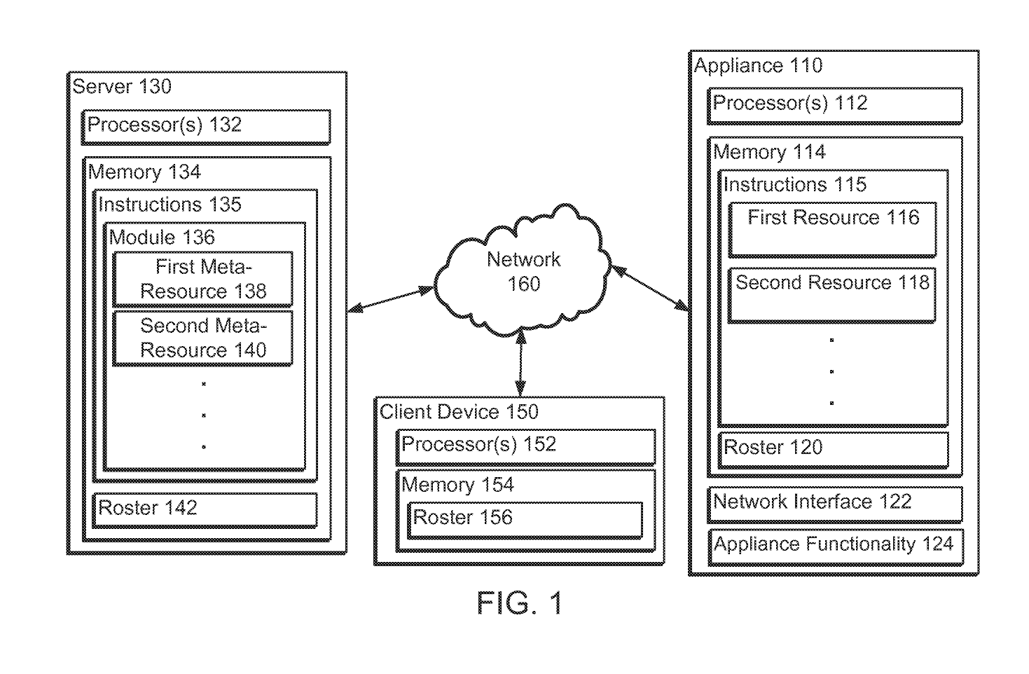

FIG. 1 provides a schematic view of a system 100 for operating an appliance 110 according to an exemplary embodiment of the present subject matter. System 100 includes appliance 110, a server 130, and a client 150. Appliance 110, server 130, and client 150 are in communication with one another via a network 160. As discussed in greater detail below, system 100 includes features for providing additional or supplemental functionality to appliance 110.

As will be understood by those skilled in the art, system 100 has a client-server architecture in the exemplary embodiment presented in FIG. 1. However, the exemplary embodiment presented in FIG. 1 is provided by way of example only. In alternative exemplary embodiments, system 100 can be implemented using other suitable architectures, such as a single computing device.

Appliance 110 includes one or more processors 112, a memory 114, and a network interface 122, and provides appliance functionality 124. As used herein, an appliance can be any machine or device for performing a specific task, including, without limitation, an air conditioner, an HVAC system controller, a security system, a camera, a ceiling fan, a clothes dryer, a clothes washer, a stereo system, a dishwasher, an energy delivery system, a refrigerator, a heater, a lighting system, a stove, an oven, a smoke detector, a television, a thermostat, a water heater, a humidity or temperature control device, an ice maker, a garbage disposal, a renewable energy system, an energy storage system, or any other suitable appliance.

Network interface 122 of appliance 110 can include any suitable components for interfacing with one more networks, such as network 160. For example, network interface 122 of appliance 110 may include transmitters, receivers, ports, controllers, antennas, or other suitable components.

The processor(s) 112 of appliance 110 can be any suitable processing device, such as a microprocessor, microcontroller, integrated circuit, or other suitable processing device. The memory 114 of appliance 110 can include any suitable computing system or media, including, but not limited to, non-transitory computer-readable media, RAM, ROM, hard drives, flash drives, or other memory devices. The memory 114 of appliance 110 can store information accessible by processor(s) 112 of appliance 110, including instructions 115 that can be executed by processor(s) 112 of appliance 110 to control various components of appliance 110 to provide appliance functionality 124. In particular, processor(s) 112 of appliance 110 can implement a resource, such as first resource 116 and/or a second resource 118, included in memory 114 of appliance 110 in order to provide appliance functionality 124 as discussed in greater detail below.

Resources of appliance 110 are stored in memory 114 of appliance 110. In the exemplary embodiment shown in FIG. 1, the resources of appliance 110 include first resource 116 and second resource 118. It should be understood that in alternative exemplary embodiments, appliance 110 can include any suitable number of resources, e.g., one, three, four, or more resources. First and second resources 116 and 118 can be organized as a Representational State Transfer or REST resource oriented architecture in memory 114 of appliance 110.

Server 130 includes one or more processors 132 and a memory 134. The processor(s) 132 of server 130 can be any suitable processing device, such as a microprocessor, microcontroller, integrated circuit, or other suitable processing device. The memory 134 of server 130 can include any suitable computing system or media, including, but not limited to, non-transitory computer-readable media, RAM, ROM, hard drives, flash drives, or other memory devices. The memory 134 of server 130 can store information accessible by processor(s) 132 of server 130, including instructions 135 that can be executed by processor(s) 132 of server 130 to control various components of server 130.

A module 136 is included or stored in memory 134 of server 130. Module 136 includes meta-resources, such as a first meta-resource 138 and a second meta-resource 140. It will be appreciated that the term “module” refers to computer logic utilized to provide desired functionality. Thus, a module can be implemented in hardware, application specific circuits, firmware and/or software controlling a general purpose processor. In one embodiment, modules are program code files stored on the storage device, loaded into memory and executed by a processor or can be provided from computer program products, for example computer executable instructions, that are stored in a tangible computer-readable storage medium such as RAM, hard disk or optical or magnetic media. Thus, while module 136 is shown stored in memory 134 of server 130 in the exemplary embodiment shown in FIG. 1, module 136 may be stored in or implemented by any other suitable component of system 100 in alternative exemplary embodiments.

In the exemplary embodiment shown in FIG. 1, meta-resources of module 136 are stored in memory 134 of server 130 and include first meta-resource 138 and second meta-resource 140. It should be understood that in alternative exemplary embodiments, module 136 can include any suitable number of meta-resources, e.g., one, three, four, or more meta-resources. First and second meta-resources 138 and 140 can be organized as a Representational State Transfer or REST resource oriented architecture in memory 134 of server 130. Meta-resources of module 136, e.g., first meta-resource 138 and/or second meta-resource 140, can supplement or augment appliance functionality 124 of appliance 110 as discussed in greater detail below.

Client 150 includes one or more processors 152 and a memory 154. The processor(s) 152 of client 150 can be any suitable processing device, such as a microprocessor, microcontroller, integrated circuit, or other suitable processing device. The memory 154 of client 150 can include any suitable computing system or media, including, but not limited to, non-transitory computer-readable media, RAM, ROM, hard drives, flash drives, or other memory devices. The memory 154 of client 150 can store information accessible by processor(s) 152 of client 150 that can be executed by processor(s) 152 of client 150 to control various components of client 150.

The client 150 can be any suitable type of computing device, such as a general purpose computer, special purpose computer, laptop, desktop, integrated circuit, mobile device, smartphone, tablet, wearable computing device, or other suitable computing device. In certain exemplary embodiments, client 150 is a web application or a mobile application.

As discussed above, appliance 110, server 130, and client 150 are in communication with one another via network 160. The network 160 can be any type of communications network, such as a local area network (e.g. intranet), wide area network (e.g. Internet), or some combination thereof The network 160 can also include a direct connection between appliance 110, server 130, and/or client 150. In general, communication between appliance 110, server 130, and/or client 150 can be carried via network interface using any type of wired and/or wireless connection, using a variety of communication protocols (e.g. TCP/IP, HTTP), encodings or formats (e.g. HTML, XML), and/or protection schemes (e.g. VPN, secure HTTP, SSL). In certain exemplary embodiments, appliance 110, server 130, and client 150 communicate with one another over network 160 via an Extensible Messaging and Presence Protocol or XMPP communications protocol.

To facilitate communication via network 160, appliance 110, server 130, and client 150 each have an associated identifier. The associated identifier can be any suitable identifier for identifying appliance 110, server 130, and client 150 or distinguishing appliance 110, server 130, and client 150 from one another. As an example, the associated identifier of appliance 110, server 130, and/or client 150 may be a Jabber ID or JID.

Appliance 110 is configured for selectively advertising the resources, e.g., first and second resources 116 and 118, of appliance 110. As an example, appliance 110 may selectively advertise first resource 116 and/or second resource 118 of appliance 100 via a publish-subscribe or Pub-Sub node or a Personal Eventing Protocol or PEP node. Module 136 is also configured for selectively advertising meta-resources, e.g., first and second meta-resources 138 and 140, of module 136. As an example, module 136 may selectively advertise first meta-resource 138 and/or second meta-resource 140 of module 136 via a publish-subscribe or Pub-Sub node or a Personal Eventing Protocol or PEP node.

As shown in FIG. 1, appliance 110 includes a roster 120, e.g., in memory 114 of appliance 110. Similarly, server 130 has a roster 142, e.g., in memory 134 of server 130, and client 150 has a roster 156, e.g., in memory 154 of client 150. The associated identifier of appliance 110 and the associated identifier of module 136 are within roster 156 of client 150. Client 150 is in operative communication with appliance 110 and module 136, e.g., such that the resources of appliance 110 are viewable and consumable by client 150 when appliance 110 advertises the resources of appliance 110 to client 150. The associated identifier of module 136 is also within roster 120 of appliance 110.

As discussed above, resources of appliance 110 can be configured for operating various components of appliance 110 in order to provide appliance functionality 124. Meta-resources of module 136 can be configured for utilizing the resources of appliance 110 in order to supplement or augment appliance functionality 124. In such a manner, the meta-resources of module 136 can provide additional or supplementary functionality to appliance 110 using the resources of appliance 100 as discussed in greater detail below.

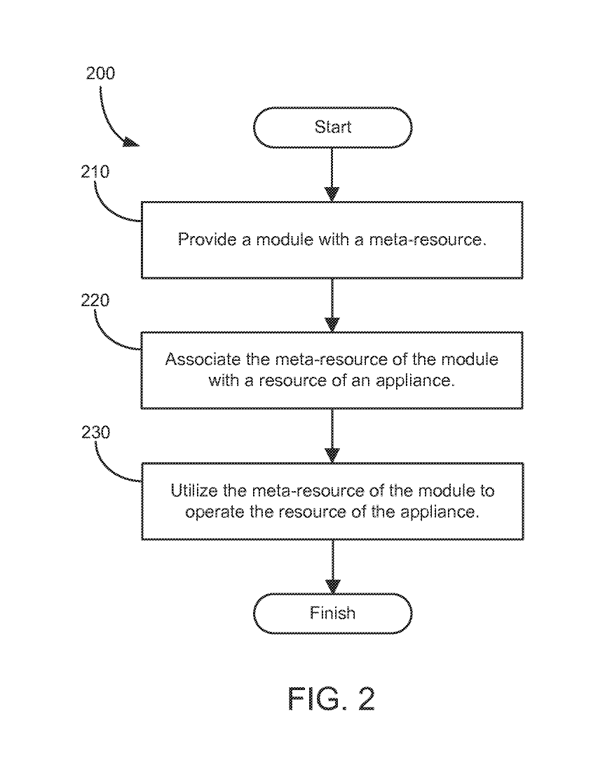

FIG. 2 illustrates a method 200 for operating an appliance according to an exemplary embodiment of the present subject matter. Method 200 can be used to operate any suitable appliance. For example, method 200 may be used to operate appliance 110 of system 100 (FIG. 1). Method 200 may be implemented by system 100. Utilizing method 200, appliance 110 can be provided with additional or augmented functionality.

At step 210, module 136 is provided. As discussed above, module 136 includes at least one meta-resource, e.g., first meta-resource 138 and/or second meta-resource 140, for supplementing functionality of appliance 110. In certain exemplary embodiments, module 136 is stored or saved in memory 134 of server 130 at step 210. In alternative exemplary embodiments, module 136 is stored or saved in memory 154 of client 150 at step 210. In other exemplary embodiments, module 136 can be stored or saved in other suitable component of system 100 at step 210.

At step 220, the meta-resource of module 136 is associated with a resource of appliance 110. As an example, first meta-resource 138 and/or second meta-resource 140 of module 136 may be associated with first resource 116 and/or second resource 118 of appliance 110 at step 220. In certain exemplary embodiments, the meta-resource of module 136 may be associated with the resource of appliance 110 by adding the associated identifier of module 136 to roster 156 of client 150 and/or to roster 120 of appliance 110 at step 220.

At step 230, the meta-resource of module 136 operates the resource of appliance 110. By utilizing the meta-resource of module 136 to operate the resource of appliance 110, appliance functionality 124 of appliance 110 can be augmented or supplemented at step 230. As an example, first resource 116 and/or second resource 118 of appliance 110 can operate to selectively activate and deactivate appliance 110, and first meta-resource 138 and/or second meta-resource 140 of module 136 can provide a timer function, e.g., a timer interval or countdown. First meta-resource 138 and/or second meta-resource 140 of module 136 can utilize first resource 116 and/or second resource 118 of appliance 110 to activate and deactivate appliance 110 according to the timer function. In such a manner, first meta-resource 138 and/or second meta-resource 140 of module 136 can utilize first resource 116 and/or second resource 118 of appliance 110 to supplement appliance functionality 124 at step 230. It should be understood the example provided above is not intended to limit the present subject matter in any aspect and that the meta-resource of module 136 can supplement appliance functionality 124 in any other suitable manner in alternative exemplary embodiments at step 230.

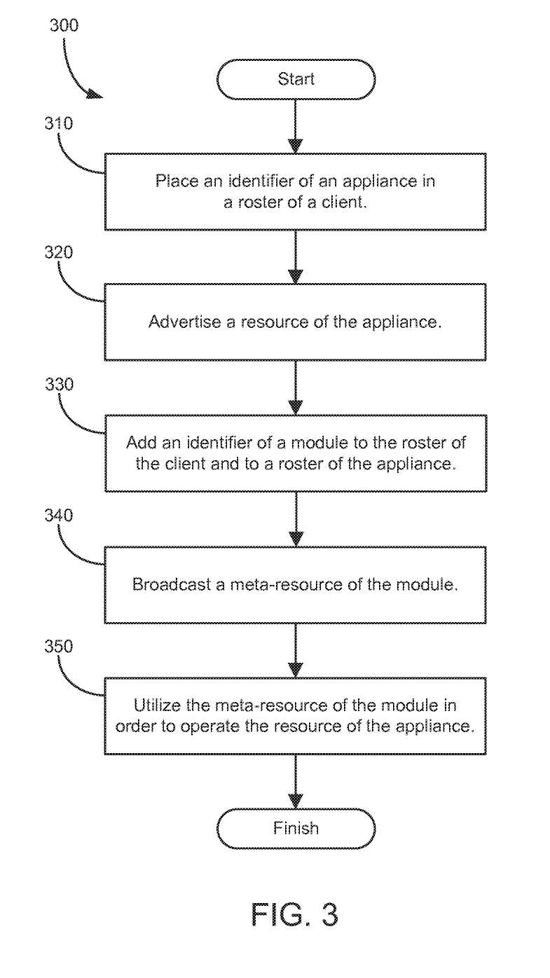

FIG. 3 illustrates a method 300 for operating an appliance according to an additional exemplary embodiment of the present subject matter. Method 300 can be used to operate any suitable appliance. For example, method 300 may be used to operate appliance 110 of system 100 (FIG. 1). Method 300 may be implemented by system 100. Utilizing method 300, appliance 110 can be provided with additional or augmented functionality.

At step 310, an associated identifier of appliance 110 is placed in roster 156 of client 150. At step 320, a resource, e.g., first resource 116 and/or second resource 118, of appliance 110 is advertised. As discussed above, the associated identifier of appliance 110 can be a Jabber ID or JID and appliance 110 can selectively advertise first resource 116 and/or second resource 118 of appliance 110 via a publish-subscribe or Pub-Sub node or a Personal Eventing Protocol or PEP node. Thus, in certain exemplary embodiments, the JID of appliance 110 is placed in roster 156 of client 150 at step 310 such that client 150 can view and consume first resource 116 and/or second resource 118 of appliance 110 when first resource 116 and/or second resource 118 of appliance 110 is advertised at step 320 using Pub-Sub or PEP nodes.

At step 330, an associated identifier of module 136 is added to roster 156 of client 150 and to roster 120 of appliance 110. With module 136 associated with appliance 110 and client 150 at step 330, module 136 establishes that a meta-resource of module 136 can supplement appliance functionality 124 of appliance 110 when first resource 116 and/or second resource 118 of appliance 110 is advertised at step 320.

At step 340, the meta-resource, e.g., first meta-resource 138 and/or second meta-resource 140, of module 136 is advertised. As discussed above, the associated identifier of module 136 can be a Jabber ID or JID and module 136 can selectively advertise first meta-resource 138 and/or second meta-resource 140 of module 136 via a publish-subscribe or Pub-Sub node or a Personal Eventing Protocol or PEP node. Thus, in certain exemplary embodiments, the JID of module 136 is placed in roster 156 of client 150 and in roster 120 of appliance 110 at step 330 such that client 150 can view and consume first meta-resource 138 and/or second meta-resource 140 of module 136 when first meta-resource 138 and/or second meta-resource 140 of module 136 is advertised at step 340 using Pub-Sub or PEP nodes. In particular, first meta-resource 138 and/or second meta-resource 140 of module 136 can be presented as a child of first resource 116 and/or second resource 118 of appliance 110 at step 340.

At step 350, the meta-resource of module 136 is utilized in order to operate the resource of appliance 110. As an example, client 150 can utilize or interact with first meta-resource 138 and/or second meta-resource 140 of module 136 in order to operate first resource 116 and/or second resource 118 of appliance 110 at step 350. In such a manner, first meta-resource 138 and/or second meta-resource 140 of module 136 can utilize first resource 116 and/or second resource 118 of appliance 110 to supplement appliance functionality 124 at step 350.

Utilizing method 200 (FIG. 2) or method 300 (FIG. 3) can provide appliance 110 with additional or supplementary functionality utilizing limited appliance native resources. In particular, the meta-resources can be cloud based in order to provide additional or supplementary functionality to appliance 110, and such additional or supplementary functionality can be provided to appliance 110 after manufacture and installation of appliance 110, e.g., without reprogramming appliance 110 or downloading such meta-resources to appliance 110. The meta-resources can be developed and provided to consumers as required by future demands and needs.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for operating an appliance, the appliance having a resource, the method comprising:
providing a module, the module having a meta-resource for supplementing functionality of the appliance;
associating the meta-resource of the module with the resource of the appliance; and
utilizing the meta-resource of the module to operate the resource of the appliance.

2. The method of claim 1, wherein said step of providing the module comprises storing the module in a memory of a server.

3. The method of claim 2, wherein the server and the appliance communicate with each other via an Extensible Messaging and Presence Protocol or XMPP communications protocol.

4. The method of claim 1, wherein said step of providing the module comprises storing the module in a memory of a client.

5. The method of claim 1, wherein said step of associating comprises adding an identifier of the module to a roster of the client and to a roster of the appliance.

6. The method of claim 1, wherein the resource of the appliance is stored in a memory of the appliance, the resource being organized as a Representational State Transfer or REST resource oriented architecture in the memory of the appliance.

7. A system, comprising:
an appliance having a resource and a roster, the appliance also having an associated identifier, the appliance configured for selectively advertising the resource of the appliance;
a module having a meta-resource, the module also having an associated identifier, the module configured for selectively advertising the meta-resource of the module; and
a client in operative communication with the appliance and the module, the client having a roster;
wherein the identifier of the appliance and the identifier of the module are within the roster of the client and the identifier of the module is within the roster of the appliance; and
wherein the meta-resource of the module is configured for utilizing the resource of the appliance in order to supplement functionality of the appliance.

8. The system of claim 7, further comprising a server having a memory, the module stored within the memory of the server.

9. The system of claim 8, further comprising a network, the appliance, the server, and the client communicating with one another over the network.

10. The system of claim 9, wherein the appliance, the server, and the client communicating with one another over the network via an Extensible Messaging and Presence Protocol or XMPP communications protocol.

11. The system of claim 8, wherein the meta-resource of the module is stored in the memory of the server, the meta-resource being organized as a Representational State Transfer or REST resource oriented architecture in the memory of the server.

12. The system of claim 7, wherein the resource of the appliance is stored in a memory of the appliance, the resource being organized as a Representational State Transfer or REST resource oriented architecture in the memory of the appliance.

13. The system of claim 7, wherein the appliance is configured for selectively advertising the resource of the appliance via a publish-subscribe or Pub-Sub node or a Personal Eventing Protocol or PEP node.

14. The system of claim 7, wherein the associated identifier of the appliance comprises a Jabber ID or JID.

15. The system of claim 7, wherein the client comprises a web application or a mobile application.

16. The system of claim 7, wherein the client is in operative communication with the appliance such that the resource of the appliance is viewable and consumable by the client.

17. A method for operating an appliance, the appliance having a resource and an identifier, a client being in communication with the appliance and a module, the module having a meta-resource and an identifier, the method comprising:
placing the identifier of the appliance in a roster of the client;
advertising the resource of the appliance;
adding the identifier of the module to the roster of the client and to a roster of the appliance;
broadcasting the meta-resource of the module; and
utilizing the meta-resource of the module in order to operate the resource of the appliance.

18. The method of claim 17, wherein the appliance, the module, and the client communicating with one another via an Extensible Messaging and Presence Protocol or XMPP communications protocol.

19. The method of claim 17, wherein the resource of the appliance is stored in a memory of the appliance, the resource being organized as a Representational State Transfer or REST resource oriented architecture in the memory of the appliance, the meta-resource of the module being stored in a memory of a server, the meta-resource being organized as a Representational State Transfer or REST resource oriented architecture in the memory of the server.
